(19) United States
(12) Patent Application Publication
(10) Pub. No.: US 2023/0194385 A1
(43) Pub. Date: Jun. 22, 2023

(54) VEHICLE TESTING SYSTEM, STEERING REACTION FORCE INPUTTING DEVICE, AND STEERING FUNCTION EVALUATING METHOD

(71) Applicant: HORIBA, LTD., Kyoto (JP)

(72) Inventors: Hiroshi KAWAZOE, Kyoto (JP); Naoji UENO, Kyoto (JP); Yoshiharu GOSHIMA, Kyoto (JP)

(73) Assignee: HORIBA, LTD., Kyoto (JP)

(21) Appl. No.: 17/915,017

(22) PCT Filed: Mar. 10, 2021
(86) PCT No.: PCT/JP2021/009448

§ 371 Date: Sep. 27, 2022

(30) Foreign Application Priority Data
Mar. 27, 2020 (JP) 2020-058182

(51) Int. Cl. G01M 17/06; G01M 17/007

(52) U.S. Cl. CPC G01M 17/06; G01M 17/0072

(57) ABSTRACT

The present invention is to evaluate a steering function of a test piece which is a vehicle having an automatic steering function or a part thereof on a chassis dynamometer, and is a vehicle testing system that performs a running test of a test piece which is a vehicle having an automatic steering function or a part thereof. The vehicle testing system includes a chassis dynamometer for performing a running test of the test piece, and a steering reaction force inputting device that inputs a steering reaction force to a steering rack gear of the test piece with a tie rod being removed, in which the steering reaction force is input to the test piece traveling on the chassis dynamometer to evaluate the steering function of the test piece.

### TECHNICAL FIELD

The present invention relates to a vehicle testing system that performs a running test of a test piece which is a vehicle having a steering function or a part thereof, a steering reaction force inputting device that inputs a steering reaction force of the test piece, and a steering function evaluating method that evaluates a steering function of the test piece.

### BACKGROUND ART

Conventionally, a running test of a vehicle such as a four-wheeled vehicle may be performed using a chassis dynamometer. As described in Patent Literature 1, the chassis dynamometer includes, for example, a roller on which the front wheel is placed and a dynamometer that applies a load to the roller. Then, the vehicle is subjected to simulation traveling on the chassis dynamometer, whereby the vehicle is evaluated.

### CITATION LIST

### Patent Literatures

Patent Literature 1: JP 2010-197129 A Patent Literature 2: JP 2019-203869 A

### SUMMARY OF INVENTION

### Technical Problem

In recent years, for example, a vehicle (automatic driving vehicle) having an automatic steering function has been developed, and there is a demand for evaluating the vehicle on a chassis dynamometer.

However, the conventional chassis dynamometer has a configuration in which a rotation shaft of a front wheel roller is fixed and steering of a vehicle is not permitted, and the steering function cannot be evaluated.

As described in Patent Literature 2, a chassis dynamometer with a steering function that allows steering of a vehicle is considered, but in this chassis dynamometer, it is necessary to turn a roller and a dynamometer, and the device configuration is large and expensive. In addition, since the rollers and the dynamometer, which are heavy objects, are turned, there is a problem that controllability is affected.

The present invention has been made in view of the above-described problems, and a main object thereof is to evaluate a steering function of a test piece which is a vehicle having a steering function or a part thereof on a chassis dynamometer.

### Solution to Problem

That is, a vehicle testing system according to the present invention is a vehicle testing system that performs a running test of a test piece which is a vehicle having a steering function or a part thereof, the vehicle testing system including: a chassis dynamometer that performs a running test of the test piece; and a steering reaction force inputting device that inputs a steering reaction force to a steering rack gear of the test piece that travels on the chassis dynamometer.

With such a vehicle testing system, by inputting a steering reaction force to the steering rack gear of the test piece, it is possible to evaluate the steering function of the test piece while causing the test piece to travel on the chassis dynamometer while keeping the wheels of the test piece in the straight traveling state. Further, in the present invention, since the steering reaction force is directly input to the steering rack gear without using the chassis dynamometer with a steering function, it is possible to improve controllability of the steering reaction force with an inexpensive configuration.

As a specific installation mode of the steering reaction force inputting device, it is desirable that the steering reaction force inputting device be connected to the steering rack gear and the tie rod end link via an attachment.

With this configuration, by making the attachment adaptable to each vehicle, it is possible to adaptable to various test pieces without changing the basic configuration of the steering reaction force inputting device.

Here, when the test piece travels on the chassis dynamometer, the steering rack gear and the tie rod end link of the test piece relatively fluctuate up and down.

For this reason, in a case of a configuration in which the steering reaction force inputting device is connected between the steering rack gear and the tie rod end link, it is desirable that the steering reaction force inputting device has an absorption structure that absorbs a relative vertical fluctuation of the steering rack gear and the tie rod end link.

In a case of a configuration in which the steering reaction force inputting device is connected between the steering rack gear and the tie rod end link, the response characteristic of the steering rack gear changes due to the weight of the steering reaction force inputting device.

In order to reduce the influence on the response characteristics of the steering rack gear, it is desirable that the steering reaction force inputting device has a support mechanism that supports its own weight with respect to the floor.

In order to input the steering reaction force to the steering rack gear with a simple configuration, it is desirable that the steering reaction force inputting device inputs the steering reaction force to the steering rack gear of the test piece via a steering wheel or a steering shaft.

As a specific embodiment of the steering reaction force inputting device, it is conceivable that the steering reaction force inputting device includes an actuator that generates a steering reaction force, a load cell that detects a steering reaction force applied to the steering rack gear by the actuator, and a steering reaction force control part that performs feedback control of the actuator using a detection signal of the load cell.

A vehicle has a steering dead zone due to tire twist deformation, play of a steering system, or the like. In order to reproduce the dead zone, it is desirable that the steering reaction force inputting device includes an elastic element (for example, a rubber bush, a spring, and the like) that reproduces the dead zone associated with steering.

In order to accurately adjust the input steering reaction force over a wide range with a simple configuration, it is desirable that the steering reaction force inputting device includes a first actuator that generates a steering reaction force of a low frequency and a large stroke and a second actuator that generates a steering reaction force of a high frequency and a small stroke.

It is desirable that the steering reaction force inputting device includes a release mechanism that releases the steering reaction force applied to the steering rack gear when the steering force applied from the steering of the test piece reaches a predetermined threshold. With this configuration, the steering reaction force inputting device can be protected.

The vehicle testing system of the present invention preferably further includes a driving robot that automatically operates the test piece. By performing a running test of the test piece by the driving robot, it is possible to suppress variations in driving and to perform a highly accurate running test as compared with a case where a person drives the test piece.

As a specific embodiment of the steering reaction force control part that controls an actuator, it is desirable that the steering reaction force control part calculates a command value of the actuator from a vehicle speed signal indicating a vehicle speed of the test piece or a steering angle signal indicating a steering angle of the test piece, and controls the actuator based on the command value.

Here, in order to evaluate the steering function by inputting a steering reaction force due to a self-aligning torque, it is desirable that the steering reaction force control part calculates the self-aligning torque from the steering angle signal and calculates a command value based on the self-aligning torque.

Further, in order to evaluate the steering function by inputting a steering reaction force at a low speed and at a stop, it is desirable that the steering reaction force control part calculates a command value to the actuator at a low speed and at a stop from a vehicle speed signal indicating a vehicle speed of the test piece.

In order to evaluate the steering function by inputting a steering reaction force irrelevant to a vehicle model, it is desirable that the steering reaction force control part calculates a command value of the actuator based on a vehicle abnormality, a road surface change, or a disturbance other than those.

(1) Vehicle abnormality: Misalignment of the steering system, drifting, tire deformation friction, and the like
(2) Road surface change: Ice burn, μ jump (change in adhesion resistance between a tire and a road surface), and the like.
(3) Other disturbances: Trace, cross wind, partial slope, rough road, curbstone contact, derricking wheel, and the like.

In order to evaluate a steering function by inputting a steering reaction force due to a posture change caused by vertical movement, it is desirable that the steering reaction force control part calculates a command value to the actuator based on a steering reaction force generated by a vertical posture change of the test piece.

In order to evaluate a steering function by inputting a steering reaction force accompanying a lateral load movement during turning, it is desirable that the steering reaction force control part calculates a command value to the actuator based on a steering reaction force generated by a posture change during turning of the test piece.

In order to perform a running test in which a change in the rolling resistance due to the load movement during the turning is taken into consideration by linking the steering reaction force inputting device and the chassis dynamometer, it is desirable that the dynamometer control part that controls the chassis dynamometer calculates a moving load generated during turning of the test piece, calculates the rolling resistance of the right and left wheels or the front and rear wheels due to the moving load, and calculates a load command value of the chassis dynamometer based on the rolling resistance. With this configuration, the test piece can be evaluated in a state close to actual driving (actual environment).

In order to evaluate a steering function by inputting a steering reaction force due to a posture change during braking or acceleration, it is desirable that the steering reaction force control part calculates a command value to the actuator based on a change in steering reaction force generated by a posture change during braking or acceleration of the test piece.

In a case of sudden braking during actual driving, an inertial force acts on the vehicle, but in a case of sudden braking during traveling on the chassis dynamometer, no inertial force acts on the vehicle. In addition, calculation of deceleration at the time of traveling on the chassis dynamometer is obtained by differentiating the vehicle speed of the vehicle. However, since it is assumed that the wheel of the vehicle is locked and the roller of the chassis dynamometer continues to rotate at the time of sudden braking, the deceleration cannot be calculated.

Therefore, in order to evaluate a steering function by inputting a steering reaction force due to a posture change at the time of sudden braking, it is desirable that the steering reaction force control part calculates a command value to the actuator based on a change in steering reaction force caused by a posture change due to a maximum acceleration calculated from the test piece specifications without using a vehicle speed signal indicating a vehicle speed of the test piece at the time of sudden braking of the test piece.

Further, the steering reaction force inputting device according to the present invention evaluates a steering function of a test piece which is an automatic driving vehicle or a part thereof on the chassis dynamometer, and applies a steering reaction force to the steering rack gear of the test piece based on a steering angle and a vehicle speed of the test piece.

Further, the steering function evaluation device according to the present invention evaluates a steering function of a test piece which is an automatic driving vehicle or a part thereof on the chassis dynamometer. The steering function evaluation device evaluates the steering function of the test piece by setting wheels of the test piece to a straight traveling state, causing the test piece to travel on the chassis dynamometer, and inputting a steering reaction force to the steering rack gear of the test piece.

### Advantageous Effects of Invention

According to the present invention described above, the steering function of a test piece which is a vehicle having an automatic steering function or a part thereof can be evaluated on the chassis dynamometer.

### BRIEF DESCRIPTION OF DRAWINGS

FIG. 1 is an overall schematic diagram of a vehicle testing system according to an embodiment of the present invention.

FIG. 2 is a schematic diagram illustrating a configuration of a steering reaction force inputting device according to the embodiment.

FIG. 3 is a schematic diagram illustrating a specific configuration of the steering reaction force inputting device according to the embodiment.

FIG. 4 is a schematic diagram illustrating a steering reaction force due to a posture change (Bounce) caused by vertical movement.

FIG. 5 is a schematic diagram illustrating a steering reaction force due to lateral load movement (roll) during turning.

FIG. 6 is a schematic diagram illustrating a steering reaction force due to a posture change (pitch) at the time of braking.

FIG. 7 is a schematic diagram illustrating control contents of a chassis dynamometer at the time of turning.

FIG. 8 is a schematic diagram illustrating a difference between the time of sudden braking in actual driving and the time of sudden braking on the chassis dynamometer.

FIG. 9 is a schematic diagram illustrating a modification of the steering reaction force inputting device.

FIG. 10 is a schematic diagram illustrating a modification of the steering reaction force inputting device.

FIG. 11 is a schematic diagram illustrating a modification of the steering reaction force inputting device.

FIG. 12 is a schematic diagram illustrating a modification of the steering reaction force inputting device.

FIG. 13 is a schematic diagram illustrating a modification of the steering reaction force inputting device.

### REFERENCE SIGNS LIST

100 vehicle testing system
W test piece
W4 steering rack gear
W5 tie rod end link
2 chassis dynamometer
25 dynamometer control part
4 driving robot
3 steering reaction force inputting device
31 actuator
32 load cell
33 steering reaction force control part
39 absorption structure
36 elastic element
37 support mechanism
38 release mechanism
311 first actuator
312 second actuator

### DESCRIPTION OF EMBODIMENTS

Hereinafter, a vehicle testing system according to an embodiment of the present invention will be described with reference to the drawings.

A vehicle testing system 100 of the present embodiment evaluates a steering function of a steering system of a test piece W which is a vehicle having a steering function or a part thereof.

Hereinafter, a completed vehicle of an automatic driving vehicle will be described as an example of the test piece W. However, the test piece W is not limited to the completed vehicle as long as it has an automatic steering function and can travel on the chassis dynamometer. The test piece may be a vehicle having no automatic steering function.

### 1. System Configuration

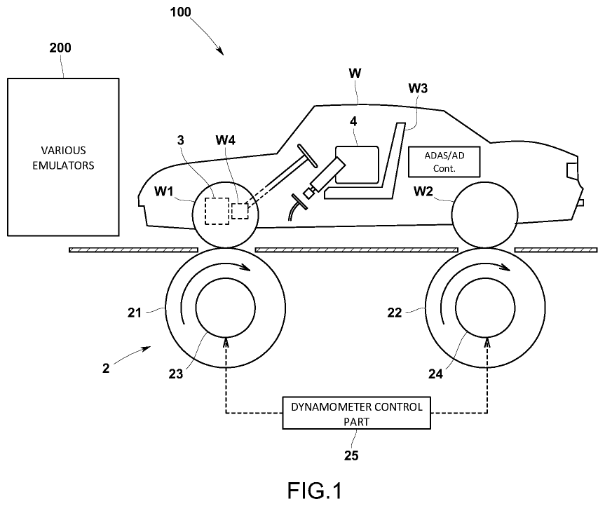

Specifically, as illustrated in FIG. 1, the vehicle testing system 100 includes a chassis dynamometer 2 for performing a running test of the test piece W, and a steering reaction force inputting device 3 for inputting a steering reaction force to a steering rack gear W4, and evaluates a steering function of the test piece W by inputting the steering reaction force to the test piece W traveling on the chassis dynamometer 2.

The chassis dynamometer 2 includes a front wheel roller 21 on which the front wheel W1 of the test piece W is placed, a rear wheel roller 22 on which the rear wheel W2 of the automatic driving vehicle W is placed, and dynamometers 23 and 24 that input loads to the front wheel roller 21 and the rear wheel roller 22, respectively. Note that, for example, a predetermined load command value based on a predetermined traveling pattern is input from a dynamometer control part 25 to the dynamometers 23 and 24, and feedback control is performed. In a case where the test piece is a front wheel-driven vehicle, the test piece may not include the rear wheel roller 22 and the dynamometer 24.

Here, a driving robot 4 is mounted on a seat W3 of the driver's seat of the test piece W (automatic driving vehicle) placed on the chassis dynamometer 2. The driving robot 4 includes various actuators for operating a steering wheel, an accelerator, a brake, or the like as necessary. The test piece W basically performs steering control, automatic cruise control, and automatic brake control by an ADAS (Advanced Driver-Assistance Systems) controller or an AD (Autonomous Driving) controller that is an evolved form of the ADAS, built in the test piece W. Note that the test piece W may be driven by a person without using the driving robot 4, or by unmanned automatic driving.

Since the test piece W placed on the chassis dynamometer 2 is an automatic driving vehicle, the test piece W includes various sensors (camera, ladder, rider, sonar, GPA, etc.) for acquiring the surrounding situation. In order to cause the automatic driving vehicle to travel on the chassis dynamometer 2, the vehicle testing system 100 includes various emulators 200 for emulating the respective sensors. The test piece W placed on the chassis dynamometer 2 is automatically driven by the ADAS controller or the AD controller based on information or a signal input by the various emulators 200.

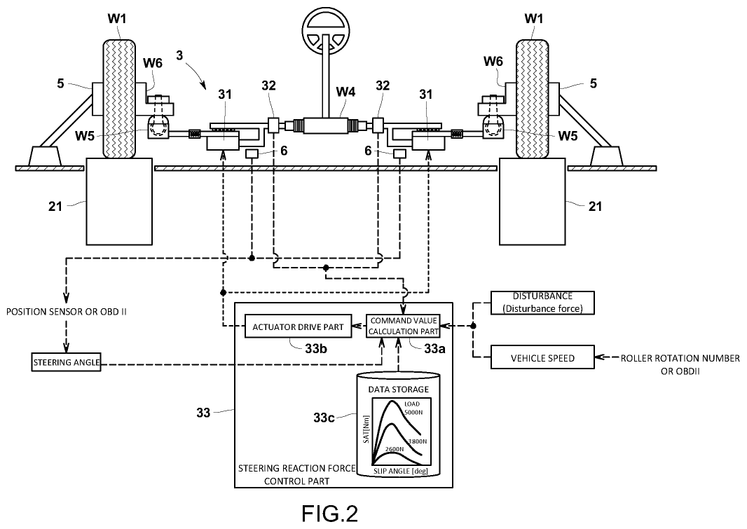

As illustrated in FIG. 2, the steering reaction force inputting device 3 inputs a steering reaction force to the steering rack gear W4 of the test piece in a state where a steering force of the steering system is not transmitted to the wheel W1 (here, in a state where a tie rod is removed,). The steering reaction force inputting device 3 of the present embodiment is connected to the steering rack gear W4 and the tie rod end link W5. The tie rod end link W5 is connected to a steering knuckle W6 fixed to the front wheel W1. In addition, the front wheel W1 from which the tie rod has been removed is made rotatable on the chassis dynamometer 2 and is fixed by a steering fixing mechanism 5 using, for example, a free hub or the like that makes it to be fixed so as not to be steered.

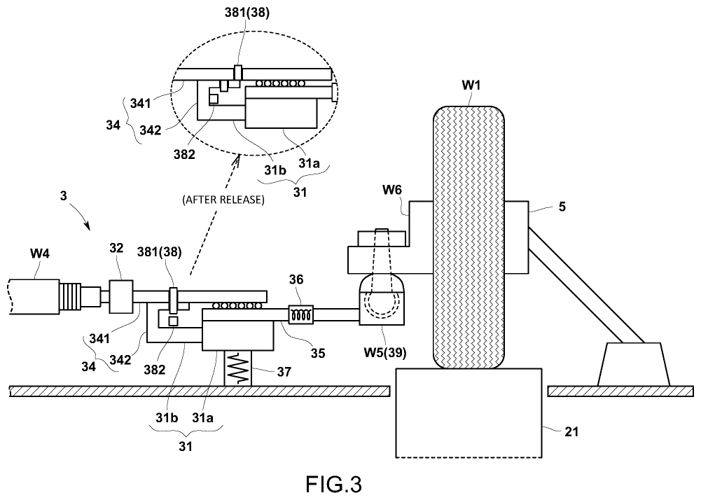

Specifically, as illustrated in FIGS. 2 and 3, the steering reaction force inputting device 3 includes an actuator 31 that generates a steering reaction force, a load cell 32 that detects a steering reaction force applied to the steering rack gear W4 by the actuator 31, and a steering reaction force control part 33 that performs feedback control of the actuator 31 using a detection signal of the load cell 32. In the present embodiment, the actuator 31 and the load cell 32 are provided at both ends of the steering rack gear W4.

The actuator 31 uses, for example, a hydraulic cylinder, a pneumatic cylinder, an electromagnetic solenoid, an electric motor, or the like, in which a movable member 31b is configured to move forward and backward with respect to an actuator main body 31a.

For example, in a case where a hydraulic cylinder or a pneumatic cylinder is provided, a piston rod which is the movable member 31b moves forward and backward with respect to a cylinder body (actuator main body 31a), whereby a steering reaction force is input to the steering rack gear W4. In a case where an electromagnetic solenoid is provided, a plunger which is the movable member 31b moves forward and backward with respect to a solenoid coil (actuator main body 31a), whereby the steering reaction force is input to the steering rack gear W4. In a case where an electric motor is provided, a ball screw mechanism is connected to the electric motor, and a ball screw nut which is a movable member 31b moves forward and backward with respect to a ball screw (actuator main body 31a), whereby a steering reaction force is input to the steering rack gear W4.

In the present embodiment, as illustrated in FIG. 3, the movable member 31b is connected to the steering rack gear W4 side, and the actuator main body 31a is connected to the tie rod end link W5 side. Here, the movable member 31b is connected to a first link member 34, and the first link member 34 is connected to the steering rack gear W4. The actuator main body 31a is connected to a second link member 35, and the second link member 35 is connected to the tie rod end link W5. Note that the first link member 34 or the second link member 35 may be configured to be stretchable so that the length can be adjusted according to the distance between the steering rack gear W4 and the tie rod end link W5.

In addition, as illustrated in FIG. 3, the steering reaction force inputting device 3 of the present embodiment may include an elastic element 36 that reproduces a dead zone associated with steering. The elastic element 36 is provided independently of feedback control of the actuator 31, and is provided in series with respect to the actuator 31, that is, between the actuator 31 and the steering rack gear W4 or between the actuator 31 and the tie rod end link W5. As the elastic element 36, for example, a rubber bush, a spring, and the like can be used. The elastic element 36 may be incorporated in the actuator 31.

In addition, the steering reaction force inputting device 3 may include an absorption structure 39 that absorbs a relative vertical fluctuation of the steering rack gear W4 and the tie rod end link W5. In the present embodiment, the tie rod end link W5 is used, but a link joint structure equivalent to a tie rod may be provided.

Furthermore, as illustrated in FIG. 3, the steering reaction force inputting device 3 may include a support mechanism 37 that supports its own weight with respect to the floor. The support mechanism 37 supports the actuator 31 with a reaction force that cancels the weight of the actuator 31 while absorbing the vertical fluctuation of the actuator 31, and can be configured using, for example, a spring or the like. Since the actuator 31 also vertically fluctuates, the movable member 31b of the actuator 31 is configured to be strokable while absorbing the free movement angle with respect to the actuator main body 31a.

In addition, as illustrated in FIG. 3, the steering reaction force inputting device 3 may include a release mechanism 38 that releases the steering reaction force applied to the steering rack gear W4 when the steering force applied from the steering system of the test piece W reaches a predetermined threshold value. The release mechanism 38 includes, for example, a fixing pin 381 made of resin for fixing a first element 341 on the steering rack gear W4 side and a second element 342 on the actuator 31 side constituting the first link member 34, and is configured such that the fixing pin 381 is cut and the first element 341 can move relative to the second element 342 when the steering force reaches a predetermined threshold value. In addition, a stopper 382 may be provided so that the second element 342 does not move from a predetermined position toward the actuator side so that a stroke amount of the second element 342 does not exceed an allowable stroke amount of the actuator 31.

### 2. Control Contents

Next, a specific example of a steering input by the steering reaction force inputting device 3 of the present embodiment will be described.

As illustrated in FIG. 2, the steering reaction force control part 33 calculates a command value of the actuator 31 from a vehicle speed signal indicating a vehicle speed of the test piece W or a steering angle signal indicating a steering angle of the test piece W, and controls the actuator 31 based on the command value. In the present embodiment, the steering reaction force control part 33 includes a command value calculation part 33a that calculates a command value of the actuator 31, and an actuator drive part 33b that controls the actuator 31 based on the command value.

Here, the vehicle speed signal may be acquired from an on-vehicle failure diagnostic device (OBDII; On-Board Diagnostics second generation) or the like via a CAN (Controller Area Network) of the test piece W, may be calculated from the number of rotation of the front wheel roller 21 of the chassis dynamometer 2, or may be calculated from the number of rotation of the front wheel W1 rotating together with the front wheel roller 21. In addition, the steering angle signal may be acquired from the OBDII via the CAN of the test piece W, or may be calculated from a detection signal of a position sensor 6 that detects a position of a member that moves with steering, such as the steering rack gear W4.

Next, specific control modes will be individually described. Note that the actuator 31 may be controlled by combining two or more of the following control modes.

### (1) Input Steering Reaction Force by Self-aligning Torque

In a case where the test piece W turns, the steering reaction force control part 33 calculates a self-aligning torque from the steering angle signal, calculates a command value based on the self-aligning torque and the detection signal of the load cell 32, and feedback-controls the actuator 31 based on the command value. Here, the self-aligning torque can be calculated from the relationship between the slip angle [deg] and the wheel load [kg]. Note that data indicating the relationship between the slip angle [deg] and the calculated self-aligning torque [Nm] is recorded in advance in a data storage 33c of the steering reaction force control part 33.

### (2) Input Steering Reaction Force During Stopping and Low Speed

The steering reaction force control part 33 calculates a steering reaction force from the vehicle speed signal, calculates a command value based on the steering reaction force and the detection signal of the load cell 32, and feedback-controls the actuator 31 based on the command value, at low speed and at stop (at stationary).

### (3) Input Steering Reaction Force Irrelevant to Vehicle Model

The steering reaction force control part 33 calculates a steering reaction force based on the following (a) a vehicle abnormality, (b) a road surface change, or (c) a disturbance other than those, calculates a command value based on the steering reaction force and the detection signal of the load cell 32, and feedback-controls the actuator 31 based on the command value.

(a) Vehicle abnormality: Misalignment of the steering system, drifting, tire deformation friction, and the like
(b) Road surface change: Ice burn, μ jump (change in adhesion resistance between a tire and a road surface), and the like.
(c) Other disturbances: Trace, cross wind, partial slope, rough road, curbstone contact, derricking wheel, and the like.

### (4) Input Steering Reaction Force Due to Posture Change by Vertical Movement (Bounce)

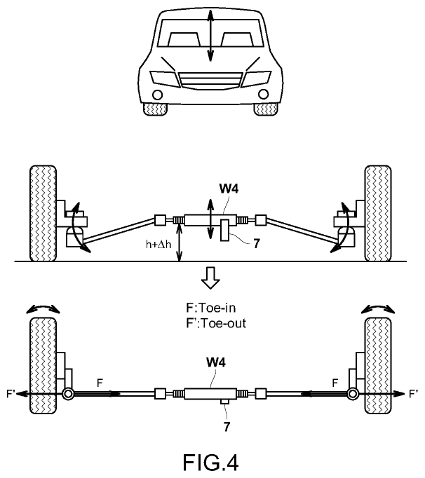

A steering change in opposite phase (toe-in, toe-out) occurs with a change in free movement angle of the tie rod due to vertical movement of the test piece W (see FIG. 4). In this case, since an input is input to the steering rack gear W4 without causing a steering angle variation, it is not possible to generate a force accompanying a steering change in opposite phase (toe-in, toe-out) in the feedback control using the steering angle signal.

Therefore, the steering reaction force control part 33 calculates a steering reaction force generated by the posture change due to the vertical movement of the test piece W, calculates a command value based on the steering reaction force and the detection signal of the load cell 32, and feedback-controls the actuator 31 based on the command value.

Here, the posture change Δh due to the vertical movement of the test piece W is calculated by a position sensor 7 that detects the height position of the steering rack gear W4. In addition, the steering reaction force F generated by the posture change Δh is calculated by a predetermined arithmetic formula F=f (Δh).

### (5) Input of Steering Reaction Force by Lateral Load Movement (Roll) During Turning

The steering reaction force control part 33 calculates a steering reaction force generated by a posture change during turning of the test piece W, calculates a command value based on the steering reaction force and a detection signal of the load cell 32, and feedback-controls the actuator 31 based on the command value.

Here, the steering reaction force is a self-aligning torque affected by a lateral load movement caused by turning.

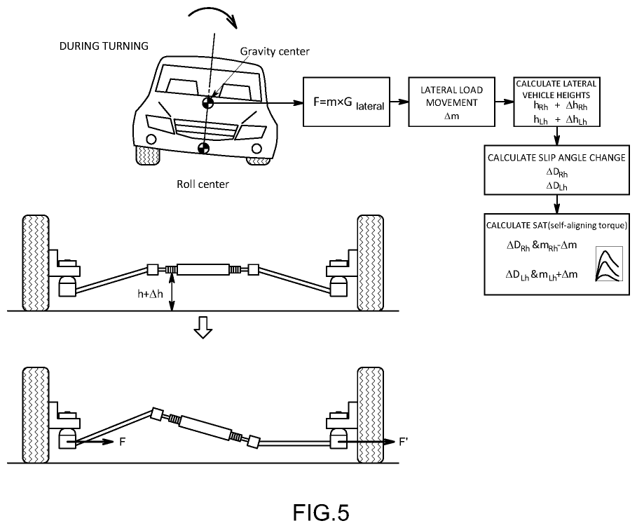

Specifically, as illustrated in FIG. 5, the centrifugal force F at the time of turning is F=m×Gₗₐₜₑᵣₐₗ from the vehicle weight m and the lateral acceleration Gₗₐₜₑᵣₐₗ.

The lateral load movement Δm generated by the centrifugal force F is calculated, and the lateral vehicle heights h_{Rh}+Δh_{Rh} and h_{Lh}+Δh_{Lh} are calculated from the calculated Δm The changes ΔD_{Rh} and ΔD_{Lh} of the slip angle can be calculated from the lateral vehicle heights.

Then, the self-aligning torque of the right front wheel can be calculated from D_{Rh}−ΔD_{Rh}, m_{Rh}−Δm, and the relationship between the slip angle [deg] and the self-aligning torque [Nm]. Furthermore, the self-aligning torque of the left front wheel can be calculated from D_{Lh}−ΔD_{Lh}, m_{Lh}−Δm, and the relationship between the slip angle [deg] and the self-aligning torque [Nm].

### (6) Input Steering Reaction Force Due to Posture Change (Pitch) During Braking or Acceleration

The steering reaction force control part 33 calculates a steering reaction force generated by a posture change of the test piece W during braking or acceleration, calculates a command value based on the steering reaction force and a detection signal of the load cell 32, and feedback-controls the actuator 31 based on the command value.

Here, the steering reaction force is a self-aligning torque affected by a longitudinal load movement generated by braking or acceleration.

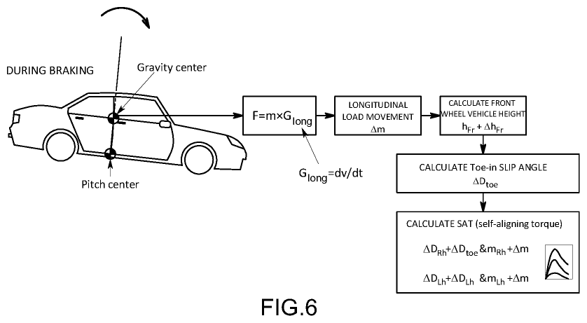

Specifically, as illustrated in FIG. 6, for example, the inertial force F at the time of braking is F=m×G_{long} from the vehicle weight m and the longitudinal acceleration G_{long}.

The longitudinal load movement Δm generated by the inertial force F is calculated, and the front wheel vehicle height h_{Fr}−Δh_{Fr} is calculated from the calculated Δm. The change ΔDₜₒₑ in the slip angle caused by toe-in can be calculated from the front wheel vehicle height.

Then, the self-aligning torque of the right front wheel can be calculated from D_{Rh}+ΔDₜₒₑ, m_{Rh}+Δm, and the relationship between the slip angle [deg], and the self-aligning torque [Nm]. Further, the self-aligning torque of the front left wheel can be calculated from D_{Lh}+ΔDₜₒₑ, m_{Lh}+Δm, and the relationship between the slip angle [deg] and the self-aligning torque [Nm].

### (7) Linkage 1 with Chassis Dynamometer 2; Control in Consideration of Change in Lateral Rolling Resistance During Turning

As described in “(5) Input of Steering Reaction Force by Lateral Load Movement (roll) during Turning” above, the rolling resistance received by each wheel from the road surface due to the lateral load movement Δm during turning.

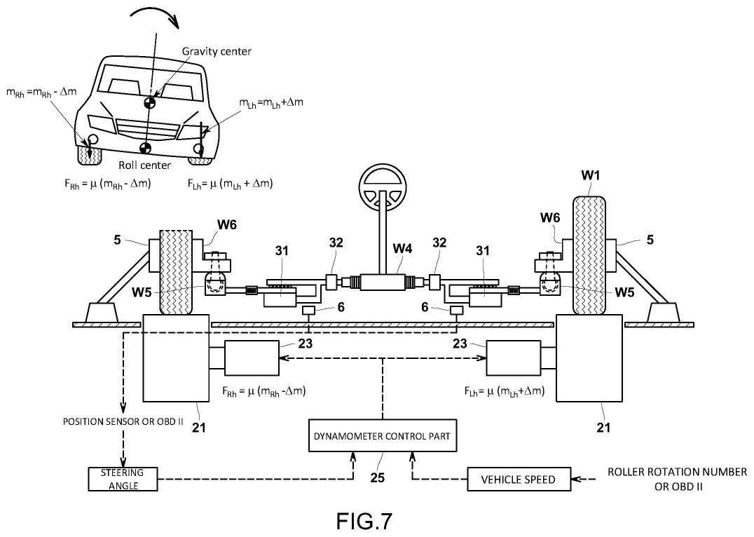

Therefore, as illustrated in FIG. 7, the dynamometer control part 25 calculates a moving load Δm generated during turning, calculates rolling resistance N (=μm) of the right and left wheels or the front and rear wheels by the moving load Δm, calculates a load command value of the chassis dynamometer 2 based on the rolling resistance N, and feedback-controls the chassis dynamometer 2. In this case, in the chassis dynamometer 2, the front wheel roller 21 and the dynamometer 23 are independently provided on each of the left and right front wheels, and a load command value corresponding to each dynamometer 23 is input. For example, when the load Δm moves from right to left, the rolling resistance F_{Rh} of the right wheel is F_{Rh}=μ(m_{Rh}−Δm), and the rolling resistance F_{Lh} of the left wheel is F_{Lh}=μ(m_{Lh}+Δm).

### (8) Linkage 2 with Chassis Dynamometer 2; Input Steering Reaction Force During Sudden Braking (Emergency Braking)

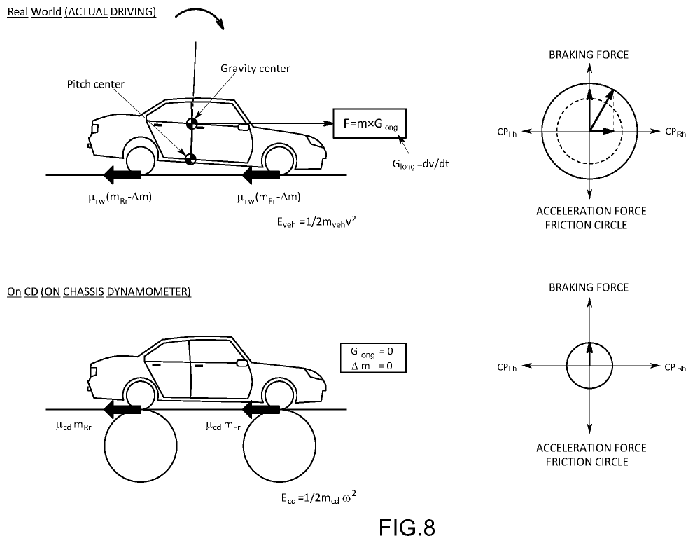

As illustrated in FIG. 8, in a case where sudden braking is performed during actual driving, the anti-lock braking system (ABS) operates to generate cornering power (CP).

On the other hand, in a case where sudden braking is performed on the chassis dynamometer 2, the longitudinal acceleration G_{long} does not occur in the vehicle, so that the longitudinal load movement Δm does not occur. The travel resistance on the chassis dynamometer 2 at this time does not match the travel resistance at the time of actual driving. Furthermore, the vehicle inertial energy at this time does not match. For this reason, the calculation of the deceleration during traveling on the chassis dynamometer 2 is usually obtained by differentiating the vehicle speed of the vehicle. However, since it is assumed that the front wheel W1 of the vehicle is locked at the time of sudden braking and the roller 21 of the chassis dynamometer 2 continues to rotate, the deceleration cannot be calculated, and the steering reaction force cannot be obtained.

Therefore, at the time of sudden braking of the test piece W, the steering reaction force control part 33 calculates the front wheel vehicle height change and the steering reaction force based on the maximum acceleration Gₘₐₓ calculated from the test piece specifications (vehicle specifications) without using the vehicle speed signal indicating the vehicle speed of the test piece W.

### 3. Effects of Present Embodiment

According to the vehicle testing system 100 of the present embodiment configured as described above, the steering reaction force is input to the steering rack gear W4 of the test piece W in a state where the steering force of the steering system is not transmitted to the wheels W1 (state in which the tie rod is removed), whereby the steering function of the test piece W can be evaluated while the test piece W is caused to travel on the chassis dynamometer 2 with the wheels W1 of the test piece W being in the straight traveling state. In addition, since the steering reaction force inputting device 3 can input various steering reaction forces to the steering rack gear W4, it is possible to evaluate the steering function under various situations on the chassis dynamometer 2.

### 4. Other Embodiments

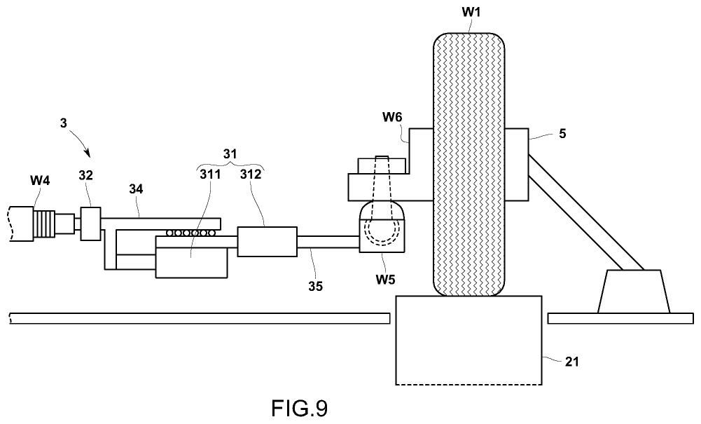

For example, the steering reaction force inputting device 3 of the above embodiment has a configuration in which one actuator 31 is provided between the steering rack gear and the tie rod end link However, as illustrated in FIG. 9, the steering reaction force inputting device 3 may be configured using two or more actuators. FIG. 9 illustrates an example including a first actuator 311 that generates a steering reaction force of a low frequency and a large stroke, and a second actuator 312 that generates a steering reaction force of a high frequency and a small stroke. Here, the first actuator 311 and the second actuator 312 are provided in series between the steering rack gear W4 and the tie rod end link W5.

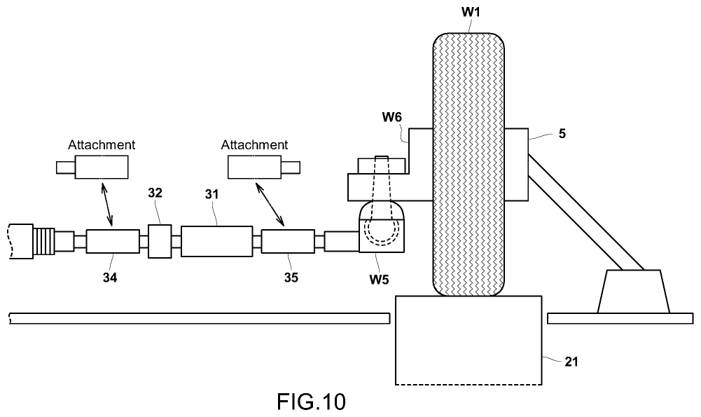

In addition, as shown in FIG. 10, the first link member 34 or the second link member 35 of the embodiment may be configured to be replaceable so that they are respectively used as an adjustment attachment that can be adjusted in accordance with the distance between the steering rack gear W4 and the tie rod end link W5. An attachment that can be adjusted in accordance with the distance between the steering rack gear W4 and the tie rod end link W5 may be used in addition to the first link member 34 and the second link member 35.

Furthermore, the steering reaction force inputting device 3 of the above embodiment actively inputs the steering reaction force to the steering rack gear W4; however, the steering reaction force may be passively input by the movement of the steering rack gear W4. In this case, it is conceivable to use a passive member such as a spring or the like as the steering reaction force inputting device 3.

In the above embodiment, the steering reaction force inputting device 3 is connected to the tie rod end link; however, it may be connected to the steering knuckle or may not be connected to the tie rod end link or the steering knuckle. In addition, the steering reaction force inputting device may be fixed to the floor. Furthermore, the steering reaction force inputting device may be fixed to another portion of the test piece W.

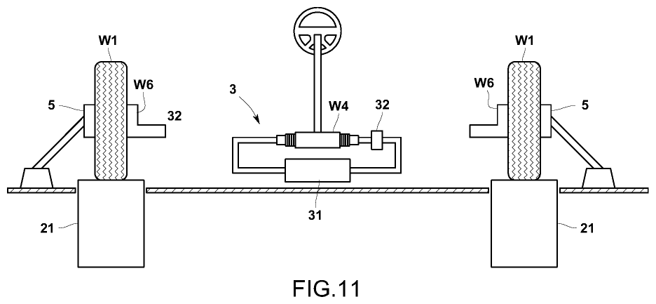

In addition, in the above embodiment, independent actuators 31 are connected to each of both ends of the steering rack gear W4. However, as illustrated in FIG. 11, a common actuator 31 may be connected to both ends of the steering rack gear W4.

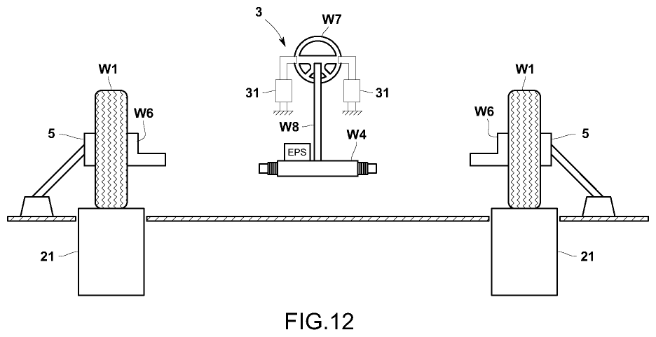

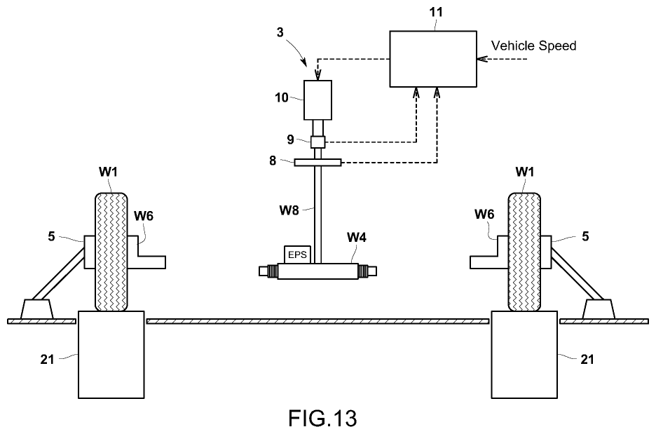

In addition, as illustrated in FIGS. 12 and 13, the steering reaction force inputting device 3 may be configured to input the steering reaction force to the steering rack gear W4 of the test piece W via the steering wheel W7 or the steering shaft W8. The steering reaction force inputting device 3 is connected to the steering wheel W7 or the steering shaft W8, and is configured using the actuator 31 as in the above embodiment. When the test piece has an automatic steering function such as an electric power steering system (EPS) or the like, it may be configured so that the automatic steering function is not stopped by the steering intervention determination. Specifically, it is conceivable that the control program of the EPS control part is modified so as not to make the steering intervention determination, a signal from the torque sensor of the steering system is not input to the EPS control part, or a dummy signal of the torque sensor is input to the EPS control part.

In a case where a steering reaction force is input via the steering shaft W8, a self-aligning torque can be generated by the actuator 31 that generates a centering force (see FIG. 12). As illustrated in FIG. 13, the steering reaction force inputting device 3 may control the steering reaction force by the steering reaction force control part 11 using a steering angle sensor 8, a reaction force generation motor 9 and a torque sensor 10 provided in the steering shaft W8. In addition, instead of using the steering angle sensor 8, the steering angle signal information may be acquired from a vehicle network (for example, CAN).

In addition, various modifications and combinations of the embodiments may be made without departing from the gist of the present invention.

### Industrial Applicability

According to the present invention, it is possible to evaluate a steering function of a test piece which is a vehicle having an automatic steering function or a part thereof on a chassis dynamometer.

1. A vehicle testing system that performs a running test on a test piece which is a vehicle having a steering function or a part thereof, the vehicle testing system comprising:
a chassis dynamometer that performs a running test of the test piece; and
a steering reaction force inputting device that inputs a steering reaction force to a steering rack gear of the test piece traveling on the chassis dynamometer.

2. The vehicle testing system according to claim 1, wherein
the steering reaction force inputting device comprises:
an actuator that generates the steering reaction force; and
a load cell that detects a steering reaction force applied to the steering rack gear by the actuator; and
a steering reaction force control part that performs feedback control of the actuator using a detection signal of the load cell.

3. The vehicle testing system according to claim 1, wherein the steering reaction force inputting device is connected to the steering rack gear and a tie rod end link via an attachment.

4. The vehicle testing system according to claim 3, wherein the steering reaction force inputting device includes an absorption structure that absorbs a relative vertical fluctuation of the steering rack gear and the tie rod end link.

5. The vehicle testing system according to claim 3, wherein the steering reaction force inputting device includes a support mechanism that supports its own weight against a floor.

6. The vehicle testing system according to claim 1, wherein the steering reaction force inputting device inputs the steering reaction force to the steering rack gear of the test piece via a steering wheel or a steering shaft.

7. The vehicle testing system according to claim 1, wherein the steering reaction force inputting device includes an elastic element that reproduces a dead zone caused by steering.

8. The vehicle testing system according to claim 1, wherein
the steering reaction force inputting device includes:
a first actuator that generates a steering reaction force of a low frequency and a large stroke; and
a second actuator that generates a steering reaction force of a high frequency and a small stroke.

9. The vehicle testing system according to claim 1, wherein the steering reaction force inputting device comprises a release mechanism that releases a steering reaction force applied to the steering rack gear in a case where a steering force applied from steering of the test piece reaches a predetermined threshold.

10. The vehicle testing system according to claim 1, further comprising a driving robot that automatically drives the test piece.

11. The vehicle testing system according to claim 2, wherein the steering reaction force control part calculates a command value of the actuator from a vehicle speed signal indicating a vehicle speed of the test piece or a steering angle signal indicating a steering angle of the test piece, and controls the actuator based on the command value.

12. The vehicle testing system according to claim 11, wherein the steering reaction force control part calculates a self-aligning torque from the steering angle signal, and calculates the command value based on the self-aligning torque.

13. The vehicle testing system according to claim 11, wherein the steering reaction force control part calculates a command value to the actuator at a low speed and at a stop from a vehicle speed signal indicating a vehicle speed of the test piece.

14. The vehicle testing system according to claim 11, wherein the steering reaction force control part calculates a command value of the actuator based on an abnormality of the test piece, a road surface change, or a disturbance other than those.

15. The vehicle testing system according to claim 11, wherein the steering reaction force control part calculates a command value to the actuator based on a steering reaction force generated by a vertical posture change of the test piece.

16. The vehicle testing system according to claim 11, wherein the steering reaction force control part calculates a command value to the actuator based on a steering reaction force generated by a posture change of the test piece during turning.

17. The vehicle testing system according to claim 16, wherein a dynamometer control part that controls the chassis dynamometer calculates a moving load generated during turning of the test piece, calculates rolling resistance of the right and left wheels due to the moving load, and calculates a load command value of the chassis dynamometer based on the rolling resistance.

18. The vehicle testing system according to claim 11, wherein the steering reaction force control part calculates a command value to the actuator based on a steering reaction force generated by a posture change of the test piece during braking or acceleration.

19. The vehicle testing system according to claim 11, wherein the steering reaction force control part calculates a command value to the actuator based on a steering reaction force generated by a posture change due to a maximum acceleration calculated from a test piece specification without using a vehicle speed signal indicating a vehicle speed of the test piece at the time of sudden braking of the test piece.

20. A steering reaction force inputting device that evaluates a steering function of a test piece which is a driving vehicle or a part thereof on a chassis dynamometer,
the steering reaction force inputting device applying a steering reaction force to a steering rack gear of the test piece based on a steering angle and a vehicle speed of the test piece.

21. A steering function evaluating method that evaluates a test piece which is a driving vehicle or a part thereof on a chassis dynamometer, the method comprising:
causing the test piece to travel on the chassis dynamometer while keeping wheels of the test piece in a straight traveling state; and
evaluating a steering function of the test piece by inputting a steering reaction force to a steering rack gear of the test piece.
